(19) United States
(12) Patent Application Publication
(10) Pub. No.: US 2014/0363095 A1
(43) Pub. Date: Dec. 11, 2014

(54) IMAGE PROCESSING DEVICE, IMAGE PROCESSING METHOD, AND PROGRAM

(71) Applicant: CANON KABUSHIKI KAISHA, Tokyo (JP)

(72) Inventor: Masanori Sato, Yokohama-shi (JP)

(21) Appl. No.: 14/369,047

(22) PCT Filed: Dec. 14, 2012
(86) PCT No.: PCT/JP2012/008021

§ 371 Date: Jun. 26, 2014

(30) Foreign Application Priority Data
Dec. 27, 2011 (JP) 2011-286781
Oct. 29, 2012 (JP) 2012-237792

(51) Int. Cl. G06T 5/00; G02B 21/34

(52) U.S. Cl. CPC G06T 5/003; G02B 21/34
USPC 382/275

(57) ABSTRACT

An image processing device includes an image obtaining unit, a displacement obtaining unit, and a displacement correcting unit. The image obtaining unit obtains data of Z-stack images including a plurality of layer images which are obtained by capturing, with a microscope device, images of an analyte at different Z-direction positions. The displacement obtaining unit obtains information regarding a displacement in an XY plane in at least one layer image among the plurality of layer images. The displacement correcting unit corrects the displacement in the at least one layer image in accordance with the information regarding the displacement.

### TECHNICAL FIELD

The present invention relates to an image processing device, an image processing method, and a program for processing data of Z-stack images.

### BACKGROUND ART

In the field of pathology, a virtual slide system is available as an alternative to an optical microscope, which is a tool for pathologic diagnosis. The virtual slide system enables a user to capture images of a specimen to be examined placed on a preparation, digitalize the captured images, and perform pathologic diagnosis on a display. With the digitalization of pathologic diagnosis using a virtual slide system, an optical microscope image of a specimen to be examined according to the related art can be handled as digital data. Accordingly, increased convenience can be expected in terms of explanation to a patient using a digital image, sharing of rare cases, higher speed in telediagnosis, higher efficiency in education and practice, and so forth.

A function of obtaining Z-stack images of virtual slide is very useful in grasping the three-dimensional structure of a target analyte (PTL 1). In this description, “Z-stack images” are data constituted by a plurality of images captured by a microscope device with a focal position being changed. Each of the images constituting the “Z-stack images” is called a “layer” or “layer image”.

### CITATION LIST

### Patent Literature

### PTL 1: Japanese Patent Laid-Open No. 2011-204243

In the case of capturing individual layer images of Z-stack images, an image capture element and an analyte (preparation) may be relatively displaced in accordance with an image capture position (Z position), due to an error of a mechanism for moving the image capture element or an error of a mechanism of a stage for moving the analyte as a target to be captured. Accordingly, a structural object such as a cell in the analyte may be displaced in each of a plurality of captured layer images, which may hinder accurate grasping of the three-dimensional structure of the structural object.

### SUMMARY OF INVENTION

Accordingly, the present invention provides an image processing device capable of reducing a displacement of a structural object in Z-stack images.

An image processing device according to an aspect of the present invention includes an image obtaining unit, a displacement obtaining unit, and a displacement correcting unit. The image obtaining unit obtains data of Z-stack images including a plurality of layer images which are obtained by capturing, with a microscope device, images of an analyte at different Z-direction positions. The displacement obtaining unit obtains information regarding a displacement in an XY plane in at least one layer image among the plurality of layer images. The displacement correcting unit corrects the displacement in the at least one layer image in accordance with the information regarding the displacement.

According to the aspect of the present invention, an image processing device capable of reducing a displacement of a structural object in Z-stack images can be provided.

Further features of the present invention will become apparent from the following description of exemplary embodiments with reference to the attached drawings.

### BRIEF DESCRIPTION OF DRAWINGS

FIG. 1 is a diagram illustrating a system configuration according to a first embodiment.

FIG. 2 is a diagram illustrating a hardware configuration according to the first embodiment.

FIG. 3 is a functional block diagram of an image processing device according to the first embodiment.

FIG. 4 is a schematic diagram illustrating positional relationships between subjects and individual layers according to the first embodiment.

FIG. 5 illustrates an ideal captured image in each layer according to the first embodiment.

FIG. 6A illustrates an actual captured image of layer 0 according to the first embodiment.

FIG. 6B illustrates an actual captured image of layer 1 according to the first embodiment.

FIG. 6C illustrates an actual captured image of layer 2 according to the first embodiment.

FIG. 7 is a flowchart illustrating a flow of image processing according to the first embodiment.

FIG. 8 illustrates feature regions extracted in a captured image of layer 0 according to the first embodiment.

FIG. 9A illustrates a feature region extracted in a captured image of layer 1 according to the first embodiment.

FIG. 9B illustrates a feature region extracted in a captured image of layer 2 according to the first embodiment.

FIG. 10 is a schematic diagram illustrating positional relationships between subjects and individual layers according to a second embodiment.

FIG. 11A illustrates an ideal captured image of layer 0 according to the second embodiment.

FIG. 11B illustrates an ideal captured image of layer 1 according to the second embodiment.

FIG. 11C illustrates an ideal captured image of layer 2 according to the second embodiment.

FIG. 11D illustrates an ideal captured image of layer 3 according to the second embodiment.

FIG. 12A illustrates an actual captured image of layer 0 and a feature region to be extracted according to the second embodiment.

FIG. 12B illustrates an actual captured image of layer 1 and feature regions to be extracted according to the second embodiment.

FIG. 12C illustrates an actual captured image of layer 2 and feature regions to be extracted according to the second embodiment.

FIG. 12D illustrates an actual captured image of layer 3 and a feature region to be extracted according to the second embodiment.

FIG. 13 is a flowchart illustrating a flow of image processing according to the second embodiment.

FIG. 14 is a diagram illustrating a system configuration according to a third embodiment.

FIG. 15 is a schematic diagram illustrating positional relationships between subjects and individual layers according to the third embodiment.

FIG. 16A illustrates an actual captured image of layer 1 according to the third embodiment.

FIG. 16B illustrates an actual captured image of layer 2 according to the third embodiment.

FIG. 17 is a flowchart illustrating a flow of image processing according to the third embodiment.

FIG. 18 illustrates an example of correspondence of feature regions according to the third embodiment.

FIG. 19 is a diagram illustrating a system configuration according to a fourth embodiment.

FIG. 20 is a diagram illustrating a configuration of a main measurement unit according to the fourth embodiment.

FIG. 21 is a functional block diagram of an image processing device according to the fourth embodiment.

FIG. 22 is a flowchart illustrating a flow of processing performed by an image capture device according to the fourth embodiment.

### DESCRIPTION OF EMBODIMENTS

Hereafter, exemplary embodiments of the present invention will be described with reference to the drawings.

### First Embodiment

A first embodiment for realizing the present invention will be described with reference to the drawings.

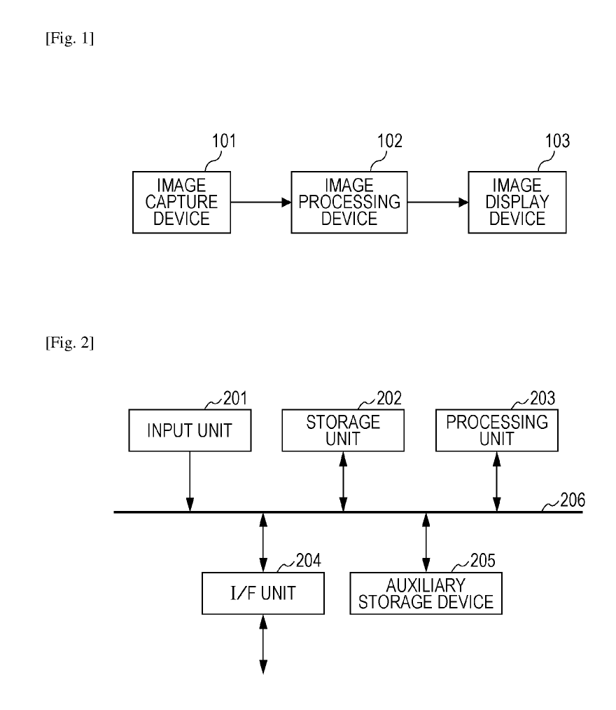

A method according to this embodiment is realized with the system configuration illustrated in FIG. 1. The system includes an image capture device (microscope device) 101, which mainly corresponds to an image capture section in a virtual slide system. The image capture device 101 photographs an analyte while changing a Z-direction position of the analyte (a position in an optical axis of an objective lens), thereby capturing images of the analyte at different Z-direction positions, and generates a plurality of layer images. The system also includes an image processing device 102, which is a main part for realizing the method according to this embodiment. The image processing device 102 receives image data (Z-stack images) generated by the image capture device 101 and performs processing thereon. The system also includes an image display device 103, which receives image data processed by the image processing device 102 and displays the image data on the screen.

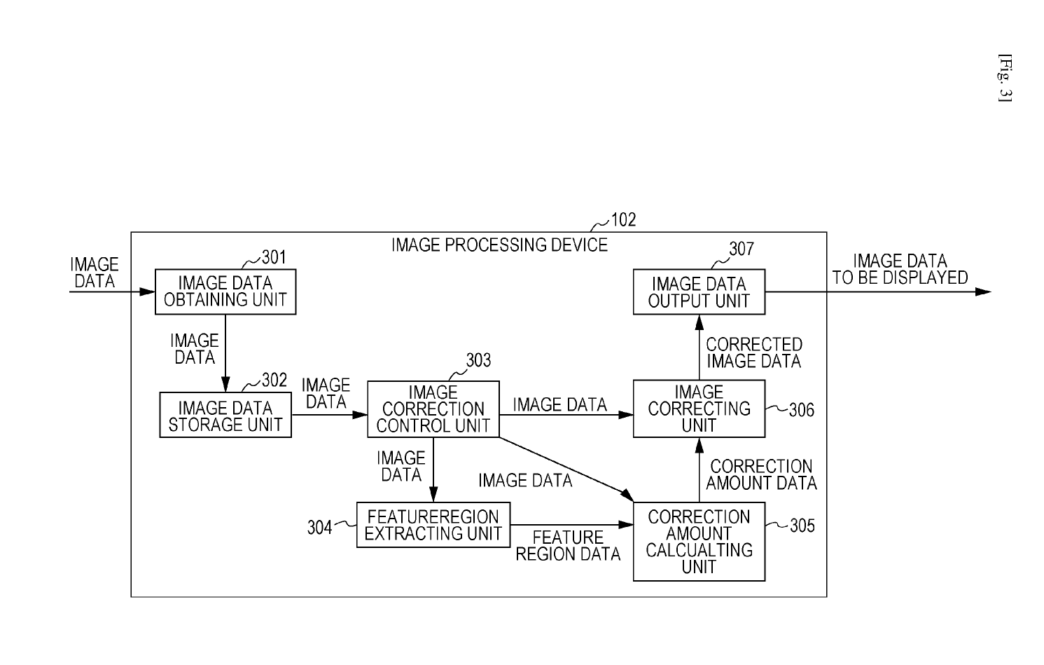

In this embodiment, the image processing device 102 is formed of, for example, the hardware configuration illustrated in FIG. 2. The hardware configuration includes an input unit 201, a storage unit 202, a processing unit 203, an interface (I/F) unit 204, and an auxiliary storage device 205. The input unit 201 may be a keyboard, mouse, or the like. The storage unit 202 may be a random access memory (RAM) or the like, and stores a program for realizing the method according to this embodiment and data to be processed. The processing unit 203 may be a central processing unit (CPU) or the like, and performs various types of processing on the data stored in the storage unit 202 in accordance with the program stored in the storage unit 202. The I/F unit 204 is an interface which controls input/output of data to/from the image capture device 101 and the image display device 103. The auxiliary storage device 205 may be a hard disk, flash memory, or the like. A data bus 206 connects the input unit 201, the storage unit 202, the processing unit 203, the I/F unit 204, and the auxiliary storage device 205. The image processing device 102 may be constituted by installing a program causing a general-purpose computer to execute the steps described below, or may be constituted by dedicated hardware and the program.

A functional block diagram of the image processing device 102 according to this embodiment is illustrated in FIG. 3. An image data obtaining unit (image obtaining unit) 301 obtains image data from the image capture device 101. An image data storage unit 302 stores image data obtained from the image data obtaining unit 301. An image correction control unit 303 performs image processing in cooperation with a feature region extracting unit (extracting unit) 304, a correction amount calculating unit (calculating unit) 305, and an image correcting unit (displacement correcting unit) 306. The feature region extracting unit 304 receives image data from the image correction control unit 303, and extracts a feature region from the image data. Extracted feature region data is transmitted to the correction amount calculating unit 305. The correction amount calculating unit 305 calculates correction amount data for each layer image (information regarding a displacement) by using the image data received from the image correction control unit 303 and the feature region data received from the feature region extracting unit 304, and transmits the calculation result to the image correcting unit 306. The functions of the feature region extracting unit 304 and the correction amount calculating unit 305 correspond to a displacement obtaining unit. The image correcting unit 306 performs coordinate transformation or the like on the image data received from the image correction control unit 303 by using the correction amount data received from the correction amount calculating unit 305, and thereby corrects the image data. This function of the image correcting unit 306 corresponds to a coordinate transformation unit. Furthermore, the image correcting unit 306 transmits the corrected image data to an image data output unit 307. The image data output unit 307 transmits the corrected image data received from the image correcting unit 306 to the image display device 103. The corrected image data is image data to be displayed.

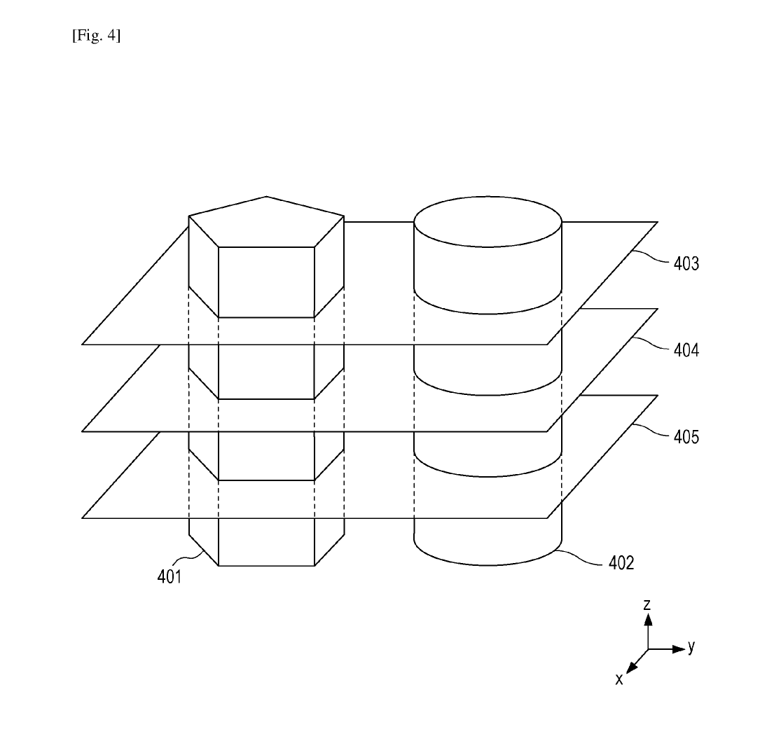

In this embodiment, the situation illustrated in FIG. 4 is discussed. FIG. 4 is a convenient schematic diagram illustrating an algorithm according to this embodiment. The structure of an actual pathological tissue or cell is more complicated.

In FIG. 4, a first structural object 401 and a second structural object 402 exist. It is assumed that the two structural objects have a simple structure and are located vertically to an XY plane. Also it is assumed that image capturing is performed on these structural objects by changing a depth, so as to obtain images of layer 0 (403), layer 1 (404), and layer 2 (405).

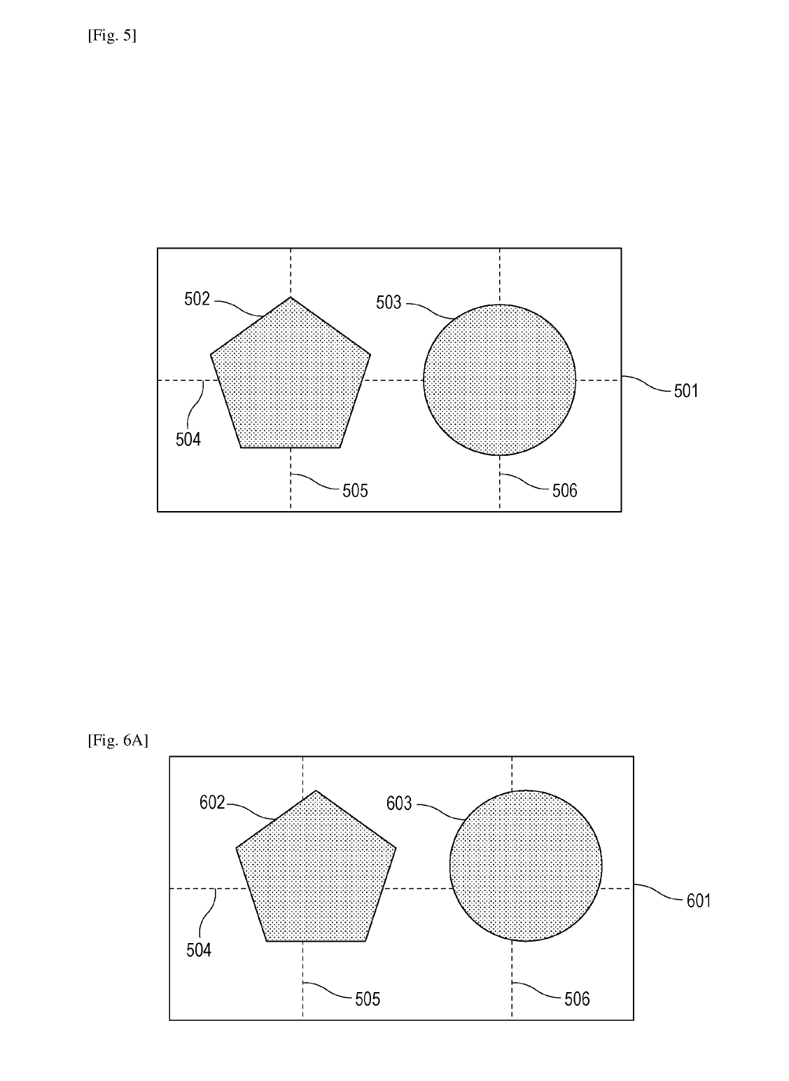

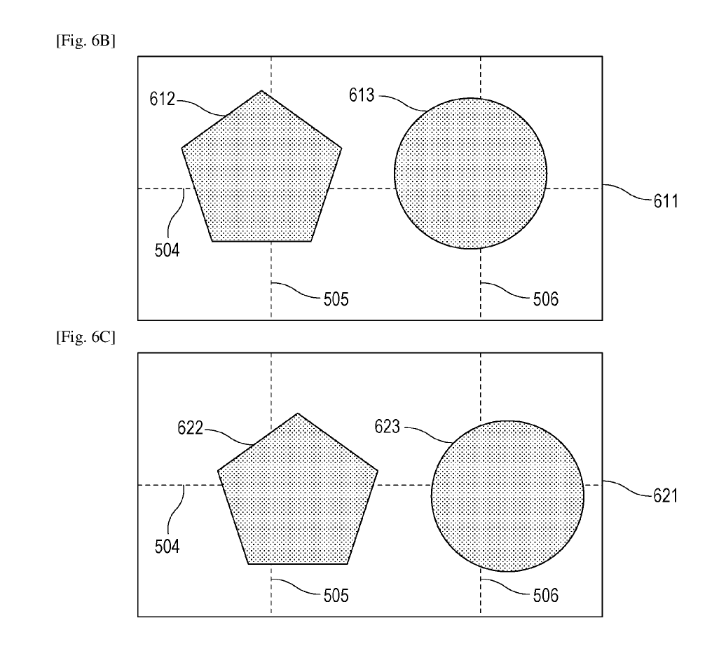

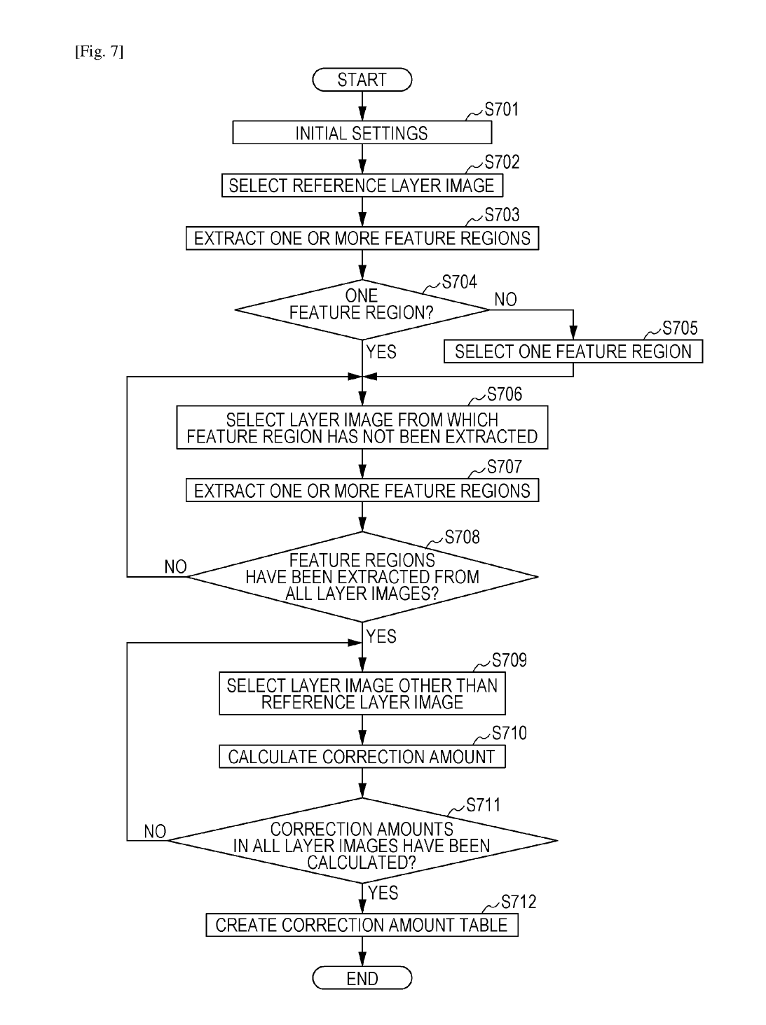

If a displacement of an image capture element does not occur during image capturing, all pieces of image data recorded as the images of layer 0 (403), layer 1 (404), and layer 2 (405) correspond to the same image 501 illustrated in FIG. 5. The image 501 is an ideal captured image in each layer, which shows a cross section 502 of the first structural object 401 and a cross section 503 of the second structural object 402. Actually, however, it is likely that these images are not identical to one another due to an error of a mechanism connected to the image capture element or a stage. For example, the images of the layer 0 (403), layer 1 (404), and layer 2 (405) are obtained as images 601, 611, and 621 illustrated in FIGS. 6A, 6B, and 6C, respectively. Reference lines 504, 505, and 506 are not actually recorded on the images, and are illustrated for the convenience of explanation to show how much cross sections 602, 603, 612, 613, 622, and 623 recorded on the images are displaced from their ideal positions. In FIGS. 6A, 6B, and 6C, the amount of displacement of each cross section is large for easy understanding. An actual amount of displacement during image capturing performed by the virtual slide system is much smaller than the amount illustrated in these figures. The image 601 is an actual captured image in layer 0 (403), the cross section 602 is a cross section in layer 0 (403) of the first structural object 401, and the cross section 603 is a cross section in layer 0 (403) of the second structural object 402. The image 611 is an actual captured image in layer 1 (404), the cross section 612 is a cross section in layer 1 (404) of the first structural object 401, and the cross section 613 is a cross section in layer 1 (404) of the second structural object 402. The image 621 is an actual captured image in layer 2 (405), the cross section 622 is a cross section in layer 2 (405) of the first structural object 401, and the cross section 623 is a cross section in layer 2 (405) of the second structural object 402.

In this embodiment, description will be given of a method for displaying image data after removing a position error with respect to these XY planes from the image data.

FIG. 7 is a flowchart illustrating a flow of image processing according to this embodiment. Hereinafter, the flow of the image processing will be described with reference to FIG. 7.

First, in step S701, various initial settings are performed.

Subsequently, in step S702, the image correction control unit 303 selects one layer image (first layer image) serving as a reference for displacement correction. This function of the image correction control unit 303 corresponds to a selecting unit of the present invention. Basically, any layer image selected from among a plurality of layer images may be used as the reference layer image.

Subsequently, in step S703, the feature region extracting unit 304 extracts, from the selected reference layer image, one or more feature regions representing one or more certain features of the image. An appropriate process such as corner extraction may be used to extract one or more feature regions. In this embodiment, each feature region may be a corner (feature point) extracted in accordance with a known corner extraction algorithm (corner detection algorithm) For example, the image 611 is selected as a reference layer image, and the corner extraction algorithm is applied to the image 611. Accordingly, corners 801 to 805 are extracted as feature points.

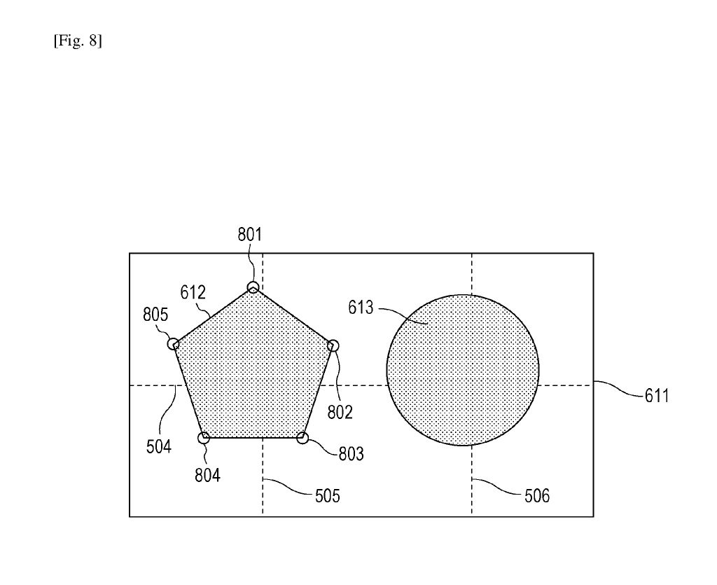

Subsequently, in step S704, the feature region extracting unit 304 determines whether or not the number of extracted feature regions is one. If the determination result in step S704 is “YES”, the process proceeds to step S706. If the determination result in step S704 is “NO”, a plurality of feature regions exist in the image, and thus the feature region extracting unit 304 selects one of the feature regions. In this case, the feature region selected from among the plurality of feature regions is not specified, and a user may set an appropriate selection method in accordance with a purpose. In this embodiment, five feature points are illustrated in FIG. 8, and the feature region extracting unit 304 selects the corner 803 from among them.

Subsequently, in step S706, the image correction control unit 303 selects a certain layer image (second layer image) from among the layer images other than the reference layer image from which a feature region has not been extracted.

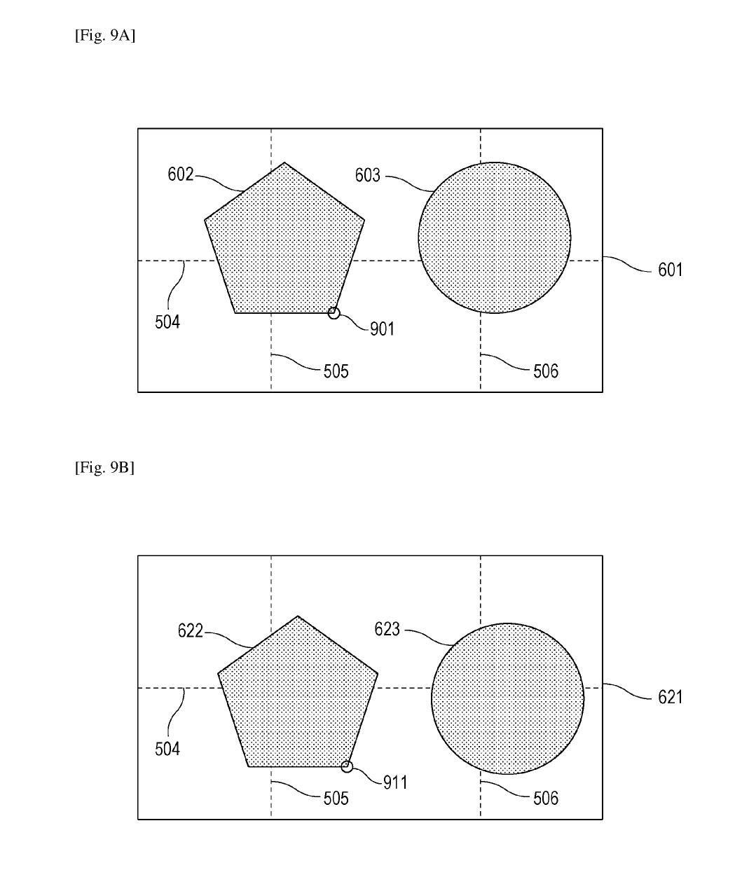

Subsequently, in step S707, the feature region extracting unit 304 extracts one or more feature regions from the selected layer image. If a plurality of feature regions are extracted in step S703, it is likely that a plurality of feature regions are extracted in step S707. Thus, in this case, a maximum amount of displacement that can be corrected may be defined in advance, and one or more feature regions may be extracted from a limited region in consideration of the position of the one feature region which has already been selected and the maximum amount of displacement with respect to the position. With this process, a feature region corresponding to the feature region which has already been extracted can be efficiently extracted. For example, when this process is applied to the images 601 and 621, the corners corresponding to the corner 803 which has already been extracted are a corner 901 in the image 601, and a corner 911 in the image 621 (FIGS. 9A and 9B).

Subsequently, in step S708, it is determined whether or not feature regions have been extracted from all the layer images. If the determination result in step S708 is “YES”, the process proceeds to step S709. If the determination result in step S708 is “NO”, the process returns to step S706.

Subsequently, in step S709, the image correction control unit 303 selects one layer image other than the reference layer image.

Subsequently, in step S710, the correction amount calculating unit 305 calculates an appropriate correction amount for the selected layer image. This function of the correction amount calculating unit 305 corresponds to the calculating unit of the present invention. Specifically, the correction amount calculating unit 305 may calculate an appropriate correction amount by using the difference between the position of the feature region in the reference layer image and the position of the feature region in the selected layer image.

Subsequently, in step S711, it is determined whether or not correction amounts in all the layer images have been calculated. If the determination result in step S711 is “YES”, the process proceeds to step S712. If the determination result in step S711 is “NO”, the process returns to step S709.

Subsequently, in step S712, the correction amount calculating unit 305 creates a correction amount table in a memory or the like and stores values obtained through calculation in the table. The correction amount table stores, as shown in Table 1, layer numbers and corresponding X-direction and Y-direction correction amounts as elements.

TABLE 1

| | X-direction | Y-direction |
|---|---|---|
| Layer number | correction amount | correction amount |
| 0 | −5 | −1 |
| 1 | 0 | 0 |
| 2 | −7 | −3 |

In this embodiment, layer 1 (404) is a reference layer, and thus the correction amounts in the X direction and Y direction for layer 1 are zero. The unit of the value of a correction amount may be appropriately set depending on a case. The easiest way is that the number of pixels is used as the unit.

After step S712, the processing ends.

The description of the flow of the image processing according to this embodiment ends now.

According to this embodiment, in the case of actually displaying a plurality of depth images, displacements in the X and Y directions in the images can be corrected using correction amounts for displayed layer images. Compared to the related art, a more accurate three-dimensional structure of a subject can be grasped.

### Second Embodiment

A second embodiment for realizing the present invention will be described with reference to the drawings.

The system configuration, hardware configuration, and functional blocks of the image processing device according to this embodiment are the same as those in the first embodiment. However, the algorithm for correcting displacements in individual layer images is different.

In the first embodiment, the situation illustrated in FIG. 4 has been discussed. In this situation, it is assumed that the subjects as targets of image capturing intersect the individual layers at right angles, and similar feature regions are extracted in all the layers at the substantially same position. However, such a situation rarely occurs in an actual pathological tissue. It is rather natural that a different feature region emerges at a different position along with change in depth during image capturing. In this case, the algorithm described in the first embodiment is not usable.

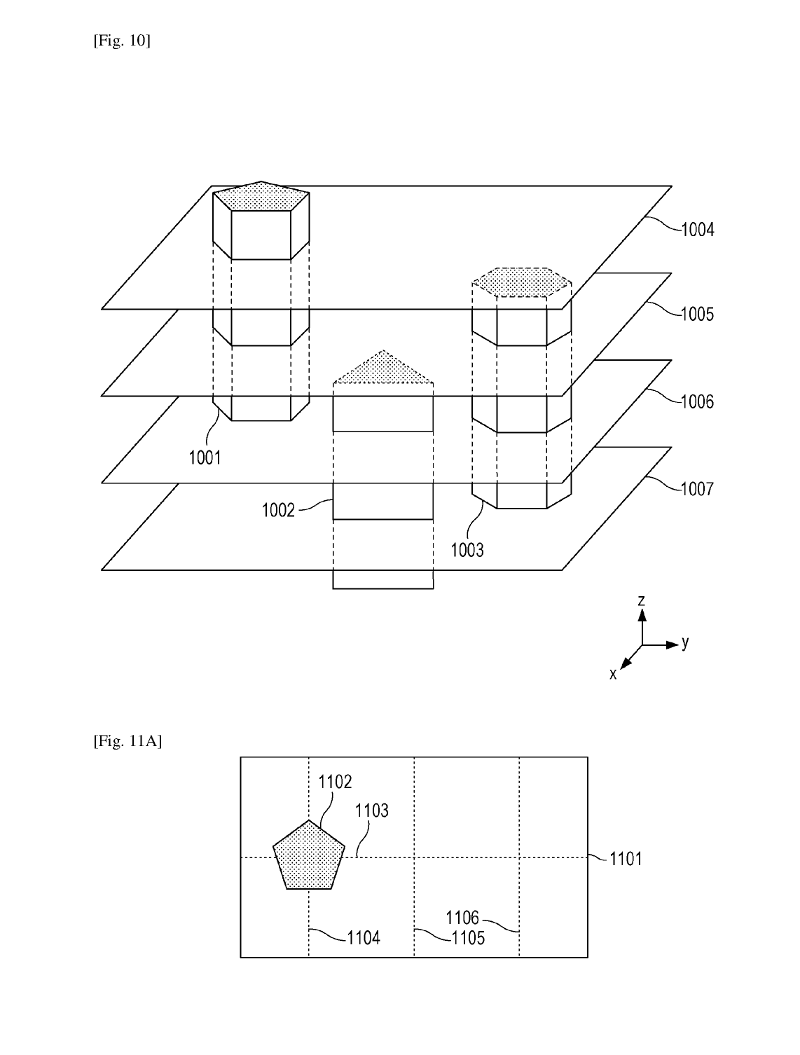

In the second embodiment, the situation illustrated in FIG. 10 is discussed. As in the first embodiment, FIG. 10 is a convenient schematic diagram illustrating an algorithm according to the second embodiment. The structure of an actual pathological tissue or cell is more complicated.

In FIG. 10, a first structural object 1001, a second structural object 1002, and a third structural object 1003 exist. The three structural objects intersect not all the layers. The first structural object 1001 intersects layer 0 (1004) and layer 1 (1005), the second structural object 1002 intersects layer 2 (1006) and layer 3 (1007), and the third structural object 1003 intersects layer 1 (1005) and layer 2 (1006). Image capturing is performed on these structural objects while changing the depth, and four layer images are sequentially obtained.

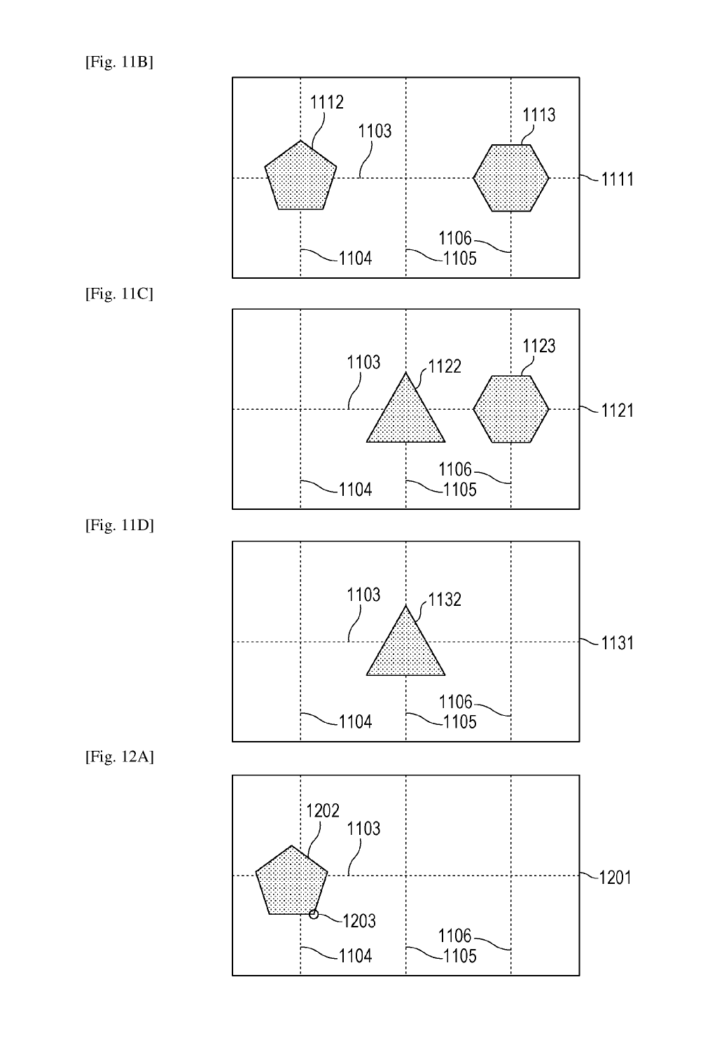

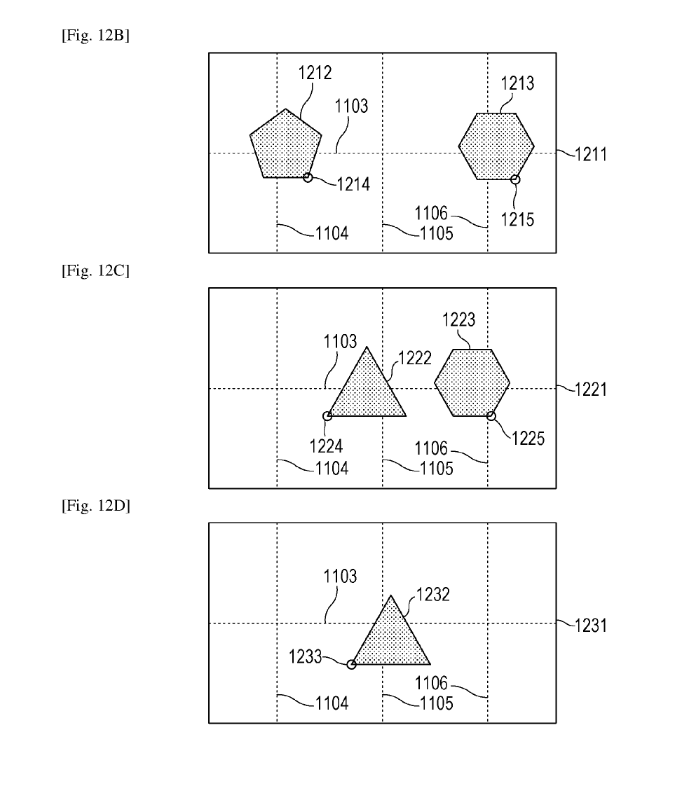

If a displacement of an image capture element or an analyte does not occur during image capturing, pieces of image data recorded as the images of layer 0 (1004) to layer 3 (1007) are images 1101, 1111, 1121, and 1131 illustrated in FIGS. 11A to 11D. Actually, however, displacements may occur in these images due to an error of a mechanism connected to the image capture element or a stage. For example, the images of layer 0 (1004) to layer 3 (1007) are actually obtained as images 1201, 1211, 1221, and 1231 illustrated in FIGS. 12A to 12D, respectively. The images 1201, 1211, 1221, and 1231 correspond to a first layer image, a second layer image, a third layer image, and a fourth layer image. Reference lines 1103, 1104, 1105, and 1106 are not actually recorded on the images, and are illustrated for the convenience of explanation to show how much cross sections 1202, 1212, 1213, 1222, 1223, and 1232 recorded on the images are displaced from their ideal positions. In FIGS. 12A to 12D, the amount of displacement of each cross section is large for easy understanding. An actual amount of displacement during image capturing performed by the virtual slide system is much smaller than the amount illustrated in these figures. The image 1101 is an ideal captured image in layer 0 (1004), and a cross section 1102 is a cross section of the first structural object 1001. The image 1111 is an ideal captured image in layer 1 (1005), a cross section 1112 is a cross section of the first structural object 1001, and a cross section 1113 is a cross section of the third structural object 1003. The image 1121 is an ideal captured image in layer 2 (1006), a cross section 1122 is a cross section of the second structural object 1002, and a cross section 1123 is a cross section of the third structural object 1003. The image 1131 is an ideal captured image in layer 3 (1007), and a cross section 1132 is a cross section of the second structural object 1002. The cross section 1202 is a cross section of the first structural object 1001, the cross section 1212 is a cross section of the first structural object 1001, the cross section 1213 is a cross section of the third structural object 1003, the cross section 1222 is a cross section of the second structural object 1002, the cross section 1223 is a cross section of the third structural object 1003, and the cross section 1232 is a cross section of the second structural object 1002.

In this embodiment, description will be given of a method for displaying image data after removing a position error with respect to these XY planes from the image data.

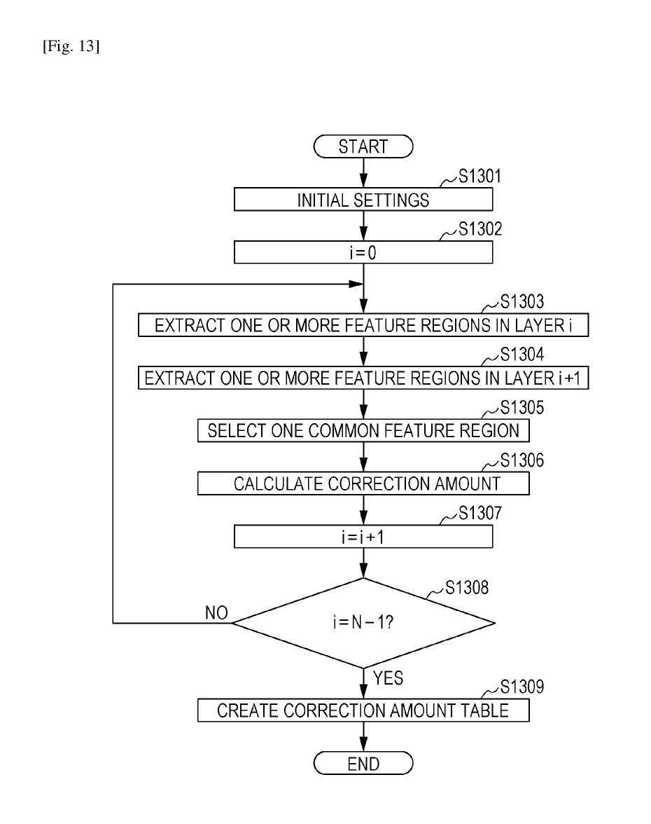

FIG. 13 is a flowchart illustrating a flow of image processing according to this embodiment. Hereinafter, the flow of the image processing will be described with reference to FIG. 13.

First, in step S1301, various initial settings are performed.

Subsequently, in step S1302, a certain integer-type variable i is prepared, and zero is assigned thereto.

Subsequently, in step S1303, one or more feature regions in layer i are extracted.

Subsequently, in step S1304, one or more feature regions in layer i+1 are extracted.

Subsequently, in step S1305, a feature region common to layer i and layer i+1 is selected. Here, “a common feature region” means, when certain two feature regions are considered, an amount of displacement therebetween is smaller than a preset maximum amount of displacement and the image patterns (features) thereof are sufficiently similar.

There may be a plurality of pairs of feature regions that satisfy the above-described conditions. In that case, any one of the pairs may be selected in the actual algorithm. For example, in this embodiment, a pair of corners 1203 and 1214 (first feature region), a pair of corners 1215 and 1225 (second feature region), and a pair of corners 1224 and 1233 (third feature region) are selected as common feature regions. The first and second feature regions, and the second and third feature regions have a displacement larger than the preset maximum amount of displacement, and/or have image patterns (features) not similar to each other.

Subsequently, in step S1306, with the use of an amount of displacement between the extracted feature region in layer i and the extracted feature region in layer i+1, a correction amount in each layer is calculated. This is a process of, for example, creating Table 2. When i is zero, layer 0 is regarded as a reference, an amount of displacement between the two feature regions is regarded as a correction amount for layer 1, and the correction amount is stored in the table.

TABLE 2

| | X-direction | Y-direction |
|---|---|---|
| Layer number | correction amount | correction amount |
| 0 | 0 | 0 |
| 1 | −5 | +4 |

Subsequently, in step S1307, the integer-type variable i is incremented by one.

Subsequently, in step S1308, it is determined whether or not the value of i is equal to N−1, where N represents the total number of layers. If the determination result in step S1308 is “YES”, the process proceeds to step S1309. If the determination result in step S1308 is “NO”, the process returns to step S1303.

Subsequently, in step S1309, a correction amount table for all the layers is created. Specifically, for example, if three tables, Table 2 to Table 4, have already been created through repetition of step S1306 (in this embodiment, N is 4), new correction amounts for layer 2 are calculated with reference to the correction amounts for layer 1 in Table 2. Likewise, new correction amounts for layer 3 are calculated with reference to the correction amounts for layer 2 in Table 3. As a result of combining all the results, Table 5 is obtained.

TABLE 3

| | X-direction | Y-direction |
|---|---|---|
| Layer number | correction amount | correction amount |
| 1 | 0 | 0 |
| 2 | +6 | 0 |

TABLE 4

| | X-direction | Y-direction |
|---|---|---|
| Layer number | correction amount | correction amount |
| 2 | 0 | 0 |
| 3 | −6 | −3 |

TABLE 5

| | X-direction | Y-direction |
|---|---|---|
| Layer number | correction amount | correction amount |
| 0 | 0 | 0 |
| 1 | −5 | +4 |
| 2 | +1 | +4 |
| 3 | −5 | +1 |

After step S1309, the processing ends.

The description of the flow of the image processing according to this embodiment ends now.

According to this embodiment, in the case of actually displaying a plurality of depth images, displacements in the X and Y directions in the images can be corrected using correction amounts for displayed layer images. Compared to the related art, a more accurate three-dimensional structure of a subject can be grasped. Also, compared to the first embodiment, correction of a displacement can be applied to a larger number of types of subject images.

### Third Embodiment

A third embodiment for realizing the present invention will be described with reference to the drawings.

The hardware configuration and functional blocks of the image processing device according to this embodiment are the same as those in the first and second embodiments. However, the system configuration and the image processing algorithm are different.

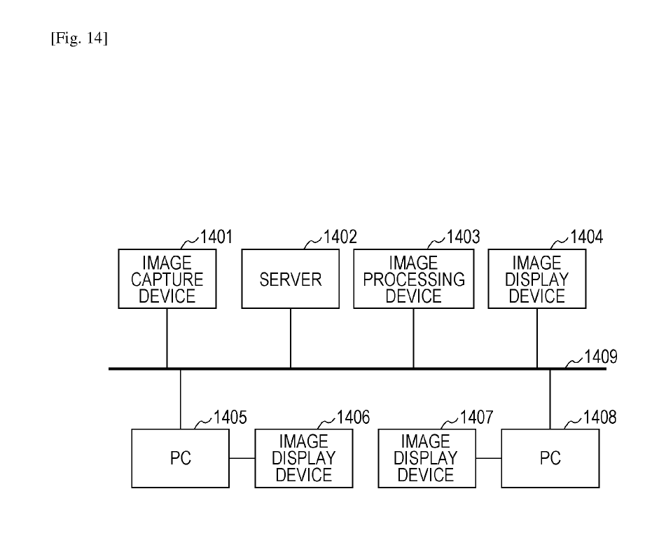

In the first and second embodiments, the system configuration illustrated in FIG. 1 is used. In the third embodiment, the system configuration illustrated in FIG. 14 connected to a network is used. Referring to FIG. 14, an image capture device 1401 mainly corresponds to an image capture section in a virtual slide system. A server 1402 stores image data or the like which has been captured or generated by the image capture device 1401. An image processing device 1403 is a main part for realizing the method according to this embodiment, reads image data stored in the server 1402, and performs processing thereon. An image display device 1404 receives image data processed by the image processing device 1403, and displays the image data on the screen. Personal computers (PCs) 1405 and 1408 are typical PCs connected to a network. Image display devices 1406 and 1407 are connected to the PCs 1405 and 1408, respectively. A network line 1409 is used for various types of data commu-nication.

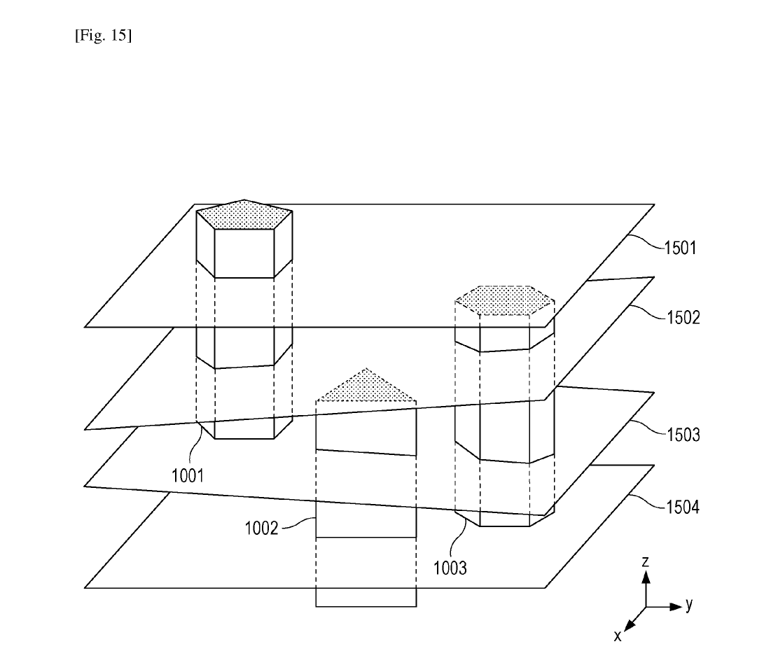

In this embodiment, the situation illustrated in FIG. 15 is discussed. As in the first and second embodiments, FIG. 15 is a convenient schematic diagram illustrating an algorithm according to this embodiment. The structure of an actual pathological tissue or cell is more complicated.

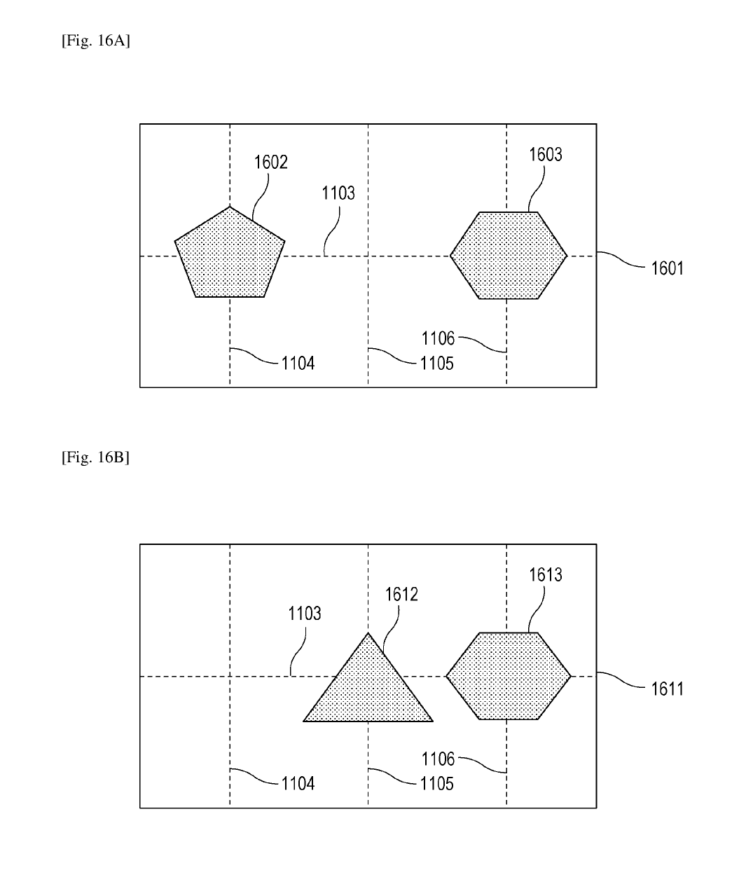

The situation illustrated in FIG. 15 is basically the same as that illustrated in FIG. 10, but is different in that layer 1 (1502) and layer 2 (1503) are inclined. This indicates that there is a displacement caused by inclination in the vertical direction of the image capture element of the image capture device 1401, in addition to a displacement in the horizontal direction. If the situation illustrated in FIG. 15 occurs, images 1601 and 1611 illustrated in FIGS. 16A and 16B are actually obtained as the image data in layer 1 (1502) and layer 2 (1503). In this example, each layer is inclined, and thus the shapes of cross sections 1602, 1603, 1612, and 1613 of the structural objects recorded on the images extend in the inclination direction. Reference numerals 1501 to 1504 denote layers 0 to 3, respectively. The image 1601 is an actual captured image in layer 1 (1502), and the image 1611 is an actual captured image in layer 2 (1503).

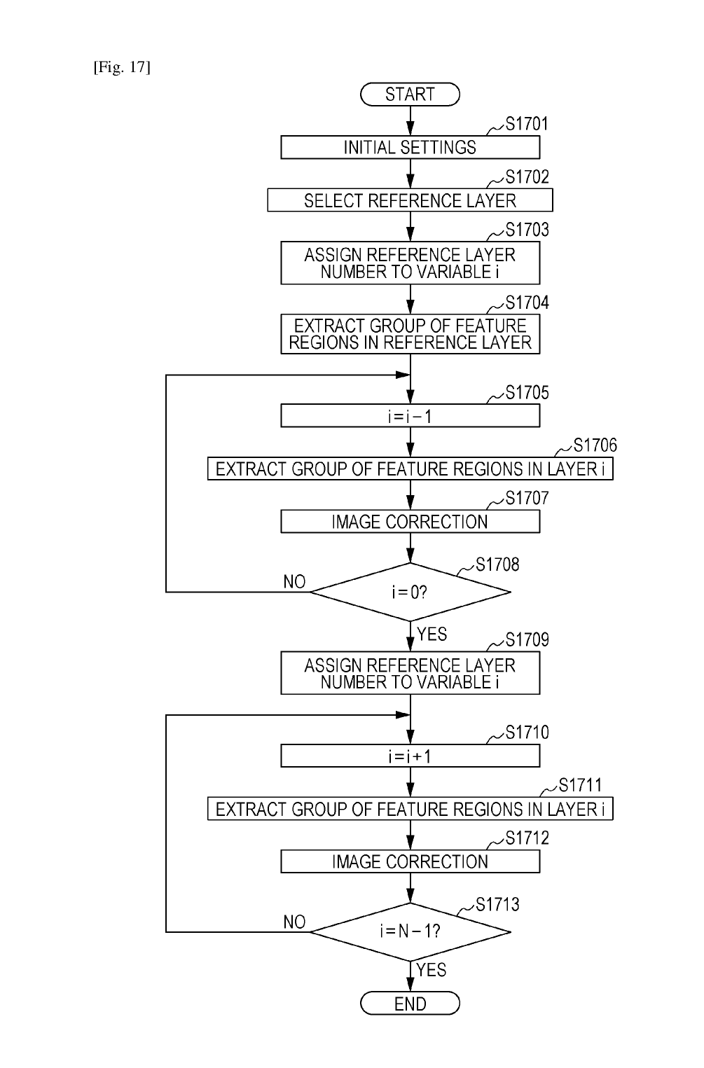

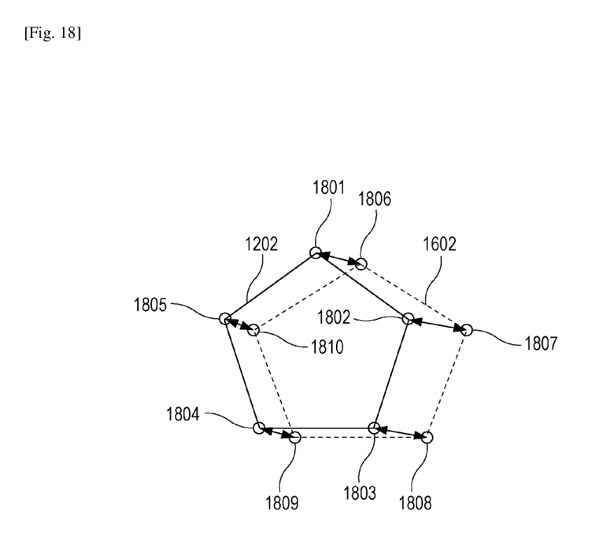

FIG. 17 is a flowchart illustrating a flow of image processing according to this embodiment. Hereinafter, the flow of the image processing will be described with reference to FIG. 17.

First, in step S1701, various initial settings are performed.

Subsequently, in step S1702, a reference layer serving as a reference of a correction process is selected. It is desirable to select, as a reference layer, a layer with no displacement caused by inclination. However, information regarding inclination is not always obtained from the image. In that case, for example, a user may directly specify a reference layer.

Subsequently, in step S1703, a certain integer-type variable i is prepared, and the layer number of the reference layer is assigned thereto.

Subsequently, in step S1704, a group of feature regions in the reference layer is extracted. In the first and second embodiments, only one feature region is selected. In the third embodiment, a plurality of feature regions are extracted, and a sufficient number of feature regions among them are used for correction.

Subsequently, in step S1705, the integer-type variable i is decremented by one.

Subsequently, in step S1706, a group of feature regions in layer i is extracted.

Subsequently, in step S1707, image correction is performed by using the groups of feature regions extracted in steps S1704 and S1706. At this time, the groups of feature regions extracted from the two layers may be associated with each other, and correction may be performed by using a method such as warping in image processing. The specific method is illustrated in FIG. 18. For example, it is assumed that the cross section 1202 of the first structural object 1001 is recorded in layer 0 (1501), and the cross section 1602 of the first structural object 1001 is recorded in layer 1 (1502). In this case, five corners 1801 to 1805 of the cross section 1202 are associated with five corners 1806 to 1810 of the cross section 1602. The position and amounts of displacement in the X and Y directions vary at each corner. Thus, if appropriate affine transform is performed, the amount of displacement between the cross sections 1202 and 1602 can be corrected, and the shapes thereof can be matched. If correction of displacement using affine transform is not ensured, more complicated nonlinear transform may be used.

Subsequently, in step S1708, it is determined whether or not i is equal to zero. If the determination result in step S1708 is “YES”, the process proceeds to step S1709. If the determination result in step S1708 is “NO”, the process returns to step S1705.

Subsequently, in step S1709, the layer number of the reference layer is assigned to variable i again.

Subsequently, in step S1710, the variable i is incremented by one.

Subsequently, in step S1711, a group of feature regions in layer i is extracted as in step 1706.

Subsequently, in step S1712, image correction is performed by using the groups of feature regions extracted in steps S1704 and S1711. A process similar to that in step S1707 may be used for the correction.

Subsequently, in step S1713, it is determined whether or not i is equal to N−1, where N represents the total number of layers. If the determination result in step S1713 is “YES”, the processing ends. If the determination result in step S1713 is “NO”, the process returns to step S1710.

The description of the flow of the image processing according to this embodiment ends now.

According to this embodiment, in the case of actually displaying a plurality of depth images, displacements in the images can be corrected using correction amounts for displayed layer images. Compared to the related art, a more accurate three-dimensional structure of a subject can be grasped. Also, compared to the first and second embodiments, captured images can be appropriately corrected even if the image capture device is displaced in an oblique direction.

### Fourth Embodiment

A fourth embodiment for realizing the present invention will be described with reference to the drawings.

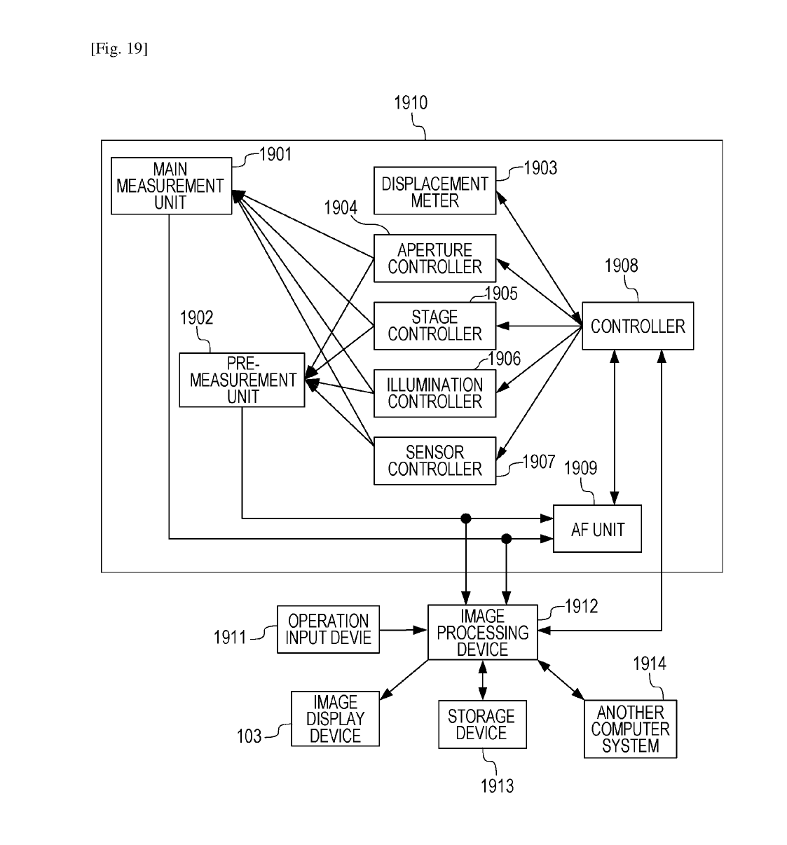

The method according to this embodiment is realized using the virtual slide system having the configuration illustrated in FIG. 19.

The virtual slide system illustrated in FIG. 19 includes an image capture device (microscope device) 1910 which obtains image data of an analyte, an image processing device 1912 which performs data processing and control, and peripheral devices of the image processing device 1912.

An operation input device 1911, such as a keyboard or mouse which receives input from a user, and the image display device 103 which displays processed images are connected to the image processing device 1912. Also, a storage device 1913 and another computer system 1914 are connected to the image processing device 1912.

In the case of capturing images of many analytes (preparations) by using a batch process, the image capture device 1910 sequentially captures images of individual analytes under the control performed by the image processing device 1912, and the image processing device 1912 performs necessary processing on pieces of image data of the individual analytes. The pieces of image data of the individual analytes obtained thereby are transmitted to the storage device 1913 serving as a large-capacity data storage or to the other computer system 1914, and are stored therein.

Image capturing by the image capture device 1910 (pre-measurement and main measurement) is realized when the image processing device 1912 provides an instruction to a controller 1908 in response to input by the user, and then the controller 1908 controls a main measurement unit 1901 and a pre-measurement unit 1902.

The main measurement unit 1901 is an image capture unit which obtains a high-resolution image used for diagnosis of an analyte on a preparation. The pre-measurement unit 1902 is an image capture unit which performs image capturing before main measurement, and obtains an image to obtain image capturing control information, in order to obtain an accurate image in main measurement.

A displacement meter 1903 is connected to the controller 1908, so that the position and distance of a preparation placed on a stage in the main measurement unit 1901 or the pre-measurement unit 1902 can be measured.

Also, an aperture controller 1904, a stage controller 1905, an illumination controller 1906, and a sensor controller 1907 which control image capture conditions of the main measurement unit 1901 and the pre-measurement unit 1902 are connected to the controller 1908. These controllers 1904 to 1907 control an aperture, a stage, illumination, and operation of an image sensor in accordance with control signals transmitted from the controller 1908.

The stage includes an XY stage which moves a preparation in a direction vertical to an optical axis, and a Z stage which moves a preparation in a direction along the optical axis. The XY stage is used to capture an analyte image extending in the direction vertical to the optical axis, and the Z stage is used to capture an image in which a focal position is changed in a depth direction. Although not illustrated, the image capture device 1910 includes a rack on which a plurality of preparations can be set, and a transport mechanism for transporting a preparation from the rack to an image capture position on the stage. In the case of performing a batch process, the controller 1908 controls the transport mechanism, so as to transport preparations one by one from the rack to the stage of the pre-measurement unit 1902 and then to the stage of the main measurement unit 1901.

An auto-focus (AF) unit 1909 which realizes auto focusing by using a captured image is connected to the main measurement unit 1901 and the pre-measurement unit 1902. The AF unit 1909 is capable of finding out an in-focus position by controlling the positions of stages of the main measurement unit 1901 and the pre-measurement unit 1902 via the controller 1908.

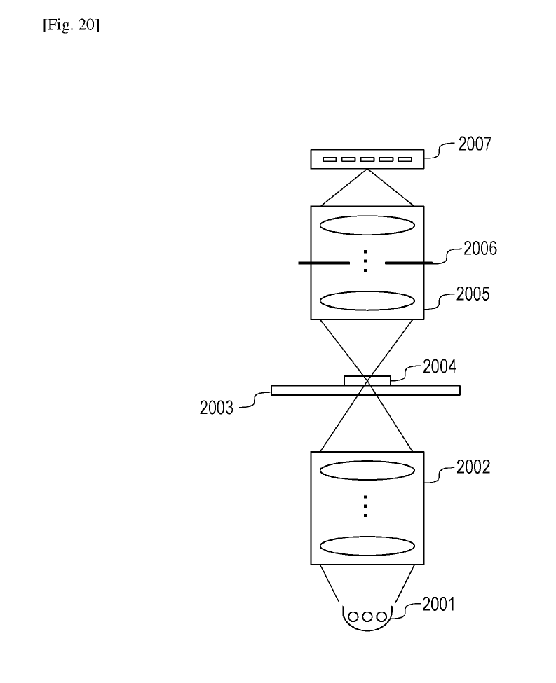

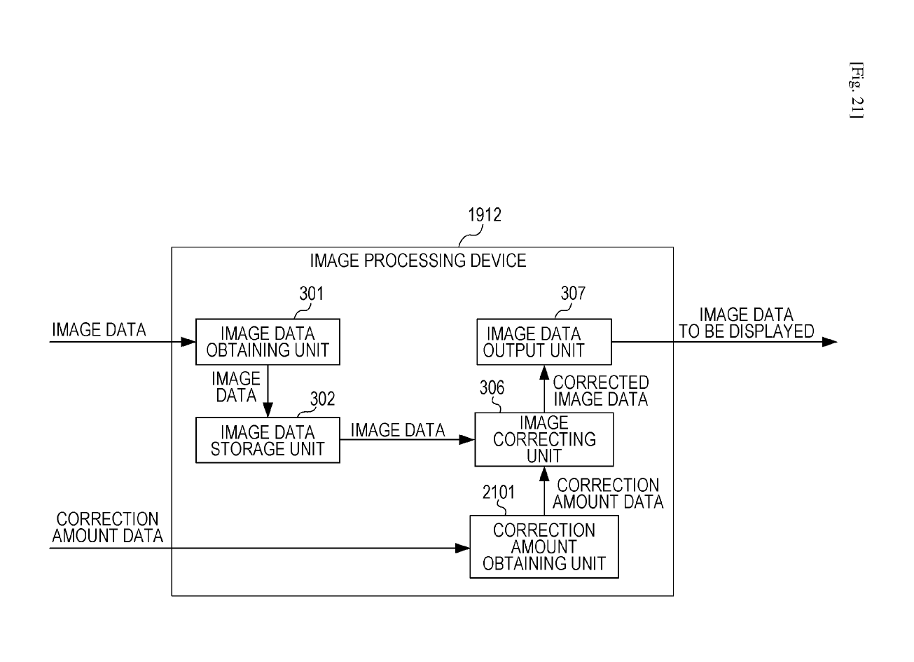

FIG. 20 is a diagram illustrating an inner configuration of the main measurement unit 1901 according to this embodiment.

Light emitted from a light source 2001 is uniformized through an illumination optical system 2002, so that variations in an amount of light are suppressed, and is applied to a preparation 2004 placed on a stage 2003. The preparation 2004 is made by putting an object to be observed, such as a piece of tissue or a smear cell, on slide glass, and fixing it under cover glass together with a mounting medium, and is prepared so that an analyte (subject) can be observed.

An image forming optical system (objective lens) 2005 is an optical system which enlarges an image of an analyte and forms the image on an image capture unit 2007. Light transmitted through the preparation 2004 is focused on an image capture plane on the image capture unit 2007 through the image forming optical system 2005. An aperture 2006 exists in the image forming optical system 2005, and the depth of field can be controlled by adjusting the aperture 2006.

At the time of image capturing, the light source 2001 is turned on, and the preparation 2004 is irradiated with light. An image formed on the image capture plane through the illumination optical system 2002, the preparation 2004, and the image forming optical system 2005 is received by an image sensor of the image capture unit 2007. In the case of capturing a monochrome (gray scale) image, exposure is performed with a white light source 2001, and image capturing is performed once. In the case of capturing a color image, exposure is sequentially performed with three light sources 2001 of RGB, and image capturing is performed three times. Accordingly, a color image is obtained.

The image of an analyte formed on the image capture plane undergoes photoelectric conversion in the image capture unit 2007, also undergoes A/D conversion, and is transmitted to the image processing device 1912 in the form of an electric signal.

FIG. 21 is a functional block diagram of the image processing device 1912 according to this embodiment. The image data obtaining unit (image obtaining unit) 301, the image data storage unit 302, the image correcting unit (displacement correcting unit) 306, and the image data output unit 307 are the same as those in the first embodiment. In the fourth embodiment, a correction amount obtaining unit (displacement obtaining unit) 2101 obtains correction amount data from the image capture device 1910, and transmits the obtained data to the image correcting unit 306. The format of the correction amount data transmitted by the correction amount obtaining unit 2101 to the image correcting unit 306 is the same as the format of the data transmitted by the correction amount calculating unit 305 to the image correcting unit 306 in the first embodiment. Thus, the method for image correction is the same as that in the first embodiment.

The correction amount data obtained by the correction amount obtaining unit 2101 is the data obtained by the displacement meter 1903, and is, in this embodiment, an absolute position of the XY stage or a relative position of the XY stage with respect to a reference position. The displacement meter 1903 is not limited as long as it is capable of obtaining data regarding a relative distance between the image sensor and an optical image of an analyte formed by the image sensor. In this embodiment, the image sensor is fixed, and thus only the position of the XY stage is measured using the displacement meter 1903.

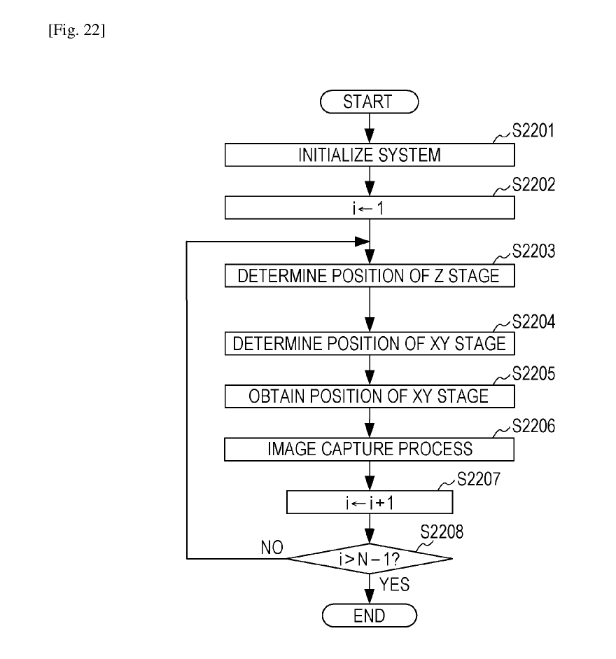

A flow of obtaining the correction amount data is illustrated in FIG. 22. Hereinafter, description will be given with reference to FIG. 22.

First, in step S2201, initialization of the image capture device 1910 is performed. The initialization includes self-diagnosis of the system, initialization of various parameters, setting of reference positions of individual stages, and checking of mutual connection among individual units.

Subsequently, in step S2202, zero is assigned to a variable i. The variable i represents a layer number. When the number of layers to be obtained is N, the variable i may be a value of any of zero to N−1.

Subsequently, in step S2203, a position of the Z stage is determined Normally, focal positions of individual layers are given from a user during capturing of Z-stack images. Thus, the position of the Z stage in image capturing for a layer number i may be determined in accordance with the data.

Subsequently, in step S2204, the XY stage is driven and the position thereof is determined. The position of the XY stage is determined by using the reference position set in step S2201. For example, when the shape of an effective image capture region of a sensor is a square whose one side has length L, the XY stage is driven to the position which is deviated from the reference position by integral multiple of L in both the X and Y directions.

Subsequently, in step S2205, an actual position of the XY stage is obtained. In this embodiment, the position of the XY stage is obtained by using the displacement meter 1903. Normally, the position data given for step S2204 matches the position obtained in step S2205. Actually, however, both positions may not match due to mechanical accuracy or the like. In order to increase accuracy of a position, steps S2204 and S2205 may be repeated using feedback control. In this embodiment, such feedback control is not performed by placing priority on high-speed processing. The data about the position of the XY stage is eventually transmitted to the image processing device 1912 as correction amount data.

Subsequently, in step S2206, the image capture unit 2007 captures an optical image of the analyte on the preparation 2004.

Subsequently, in step S2207, the variable i is incremented by one. This corresponds to an instruction to capture the next layer image by changing the focal position.

Subsequently, in step S2208, it is determined whether or not the value of the variable i is larger than N−1. If the determination result in step S2208 is “NO”, the process returns to step S2203, where the Z stage is driven again to determine the position thereof to capture the next layer image. If the determination result in step S2208 is “YES”, it is determined that all the layer images have been captured, and the processing ends.

With the above-described processing, image data and stage position data, that is, correction amount data, can be obtained.

When the value of the variable i is one or more, step S2204 may be omitted if priority is placed on processing speed. This is because the position of the XY stage is mostly determined at the time when i is zero. If the XY stage is moved in the optical-axis direction to change the layer image to be captured, the amount of movement in the horizontal direction of the XY stage may be small. In this case, a sufficient image correction effect is expected by performing correction of displacement in the horizontal direction in this embodiment.

Furthermore, practically, a region of a target of image capturing is larger than an image capture sensor in most cases. In that case, execution of the algorithm illustrated in FIG. 22 enables acquisition of only a small-block layer image group obtained by capturing images of only part of individual layers, and the XY stage information corresponding thereto. In this case, the algorithm illustrated in FIG. 22 may be repeated in the horizontal direction, and a pair of a small-block layer image group and XY stage position information corresponding thereto may be transmitted to the image processing device 1912 at each horizontal position. Furthermore, in the image processing device 1912, small-block images in which displacement in the horizontal direction has been corrected in individual layers may be combined between the image correcting unit 306 and the image data output unit 307, and resulting image data may be regarded as final corrected image data.

Now, description of the flow of image processing according to this embodiment ends.

According to this embodiment, in the case of actually displaying a plurality of depth images, displacements in the images can be corrected using correction amounts for displayed layer images. Compared to the related art, a more accurate three-dimensional structure of a subject can be grasped. Also, compared to the first and second embodiments, displacement detection based on a feature amount is not used, which decreases the load of a displacement correction process and increases the speed of a displacement correction process.

### Other Embodiments

Aspects of the present invention can also be realized by a computer of a system or apparatus (or device such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2011-286781, filed Dec. 27, 2011 and No. 2012-237792, filed Oct. 29, 2012, which are hereby incorporated by reference herein in their entirety.

1. An image processing device comprising:
an image obtaining unit configured to obtain data of Z-stack images including a plurality of layer images which are obtained by capturing, with a microscope device, images of an analyte at different Z-direction positions;
a displacement obtaining unit configured to obtain information regarding a displacement in an XY plane in at least one layer image among the plurality of layer images; and
a displacement correcting unit configured to correct the displacement in the at least one layer image in accordance with the information regarding the displacement.

2. The image processing device according to claim 1, wherein the displacement obtaining unit comprises
an extracting unit configured to extract a feature region having a certain feature in at least each of a first layer image and a second layer image among the plurality of layer images, and
a calculating unit configured to calculate an amount of displacement between the first layer image and the second layer image by using a position of the feature region in the first layer image and a position of the feature region in the second layer image.

3. The image processing device according to claim 2, wherein the extracting unit
extracts, in at least each of the first layer image and the second layer image among the plurality of layer images, a first feature region common to the first layer image and the second layer image, and
extracts, in at least each of the second layer image and a third layer image among the plurality of layer images, a second feature region common to the second layer image and the third layer image, the second feature region being different from the first feature region, and
wherein the calculating unit
calculates an amount of displacement between the first layer image and the second layer image by using a position of the first feature region in the first layer image and a position of the first feature region in the second layer image, and
calculates an amount of displacement between the second layer image and the third layer image by using a position of the second feature region in the second layer image and a position of the second feature region in the third layer image.

4. The image processing device according to claim 1, wherein the displacement obtaining unit obtains, as the information regarding the displacement, data obtained by a displacement meter of the microscope device.

5. The image processing device according to claim 4, wherein the displacement meter obtains data about a relative distance between an image sensor of the microscope device and an optical image of the analyte formed by the image sensor.

6. The image processing device according to claim 3, wherein the first layer image, the second layer image, and the third layer image are arranged in this order in the Z-stack images.

7. The image processing device according to claim 2,
wherein the extracting unit extracts a plurality of feature regions each having a certain feature, and
wherein the calculating unit calculates an amount of displacement between the first layer image and the second layer image by using positions of the feature regions in the first layer image and positions of the feature regions in the second layer image.

8. The image processing device according to claim 7, wherein the calculating unit calculates an inclination of the second layer image with respect to the first layer image.

9. The image processing device according to claim 7, further comprising:
a selecting unit configured to select, as a reference layer image, one layer image from among the plurality of layer images,
wherein the extracting unit extracts a plurality of feature regions in the reference layer image and a plurality of feature regions in layer images other than the reference layer image among the plurality of layer images, and
wherein the calculating unit calculates an amount of displacement between the reference layer image and each of the layer images other than the reference layer image, and an inclination of each of the layer images other than the reference layer image with respect to the reference layer image.

10. The image processing device according to claim 9, wherein the selecting unit selects, as the reference layer image, a layer image having the smallest inclination from among the plurality of layer images.

11. The image processing device according to claim 1, wherein the displacement correcting unit performs coordinate transformation on at least one layer image among the plurality of layer images in accordance with the information regarding the displacement.

12. The image processing device according to claim 2, wherein the feature region is a feature point.

13. An image processing method comprising:
obtaining data of Z-stack images including a plurality of layer images which are obtained by capturing, with a microscope device, images of an analyte at different Z-direction positions;
obtaining information regarding a displacement in an XY plane in at least one layer image among the plurality of layer images; and
correcting the displacement in the at least one layer image in accordance with the information regarding the displacement.

14. A computer program stored in a non-transitory computer readable medium, the program, when executed, causing a computer to execute the image processing method according to claim 13.
